(19) United States
(12) Patent Application Publication
(10) Pub. No.: US 2014/0149165 A1
(43) Pub. Date: May 29, 2014

(54) Teaching Support System

(71) Applicant: Soleis AS, Sunndalsora (NO)

(72) Inventors: Eir Magnhild HUSBY, Sunndalsora (NO); Sigrid LILLEBRÁTEN, Sunndalsora (NO)

(21) Appl. No.: 14/063,186

(22) Filed: Oct. 25, 2013

(30) Foreign Application Priority Data
Oct. 25, 2012 (GB) 1219231.6

(51) Int. Cl. G06Q 10/10; G06Q 50/20

(52) U.S. Cl. CPC G06Q 10/1095; G06Q 50/2053
USPC 705/7.19; 705/327

(57) ABSTRACT

A system for tracking the provision of education to a plurality of students comprising:
logic arranged to retrieve first data from a first database relating to a schedule of subjects taught on specific occasions;
logic arranged to retrieve second data from a second database relating to attendance of said students on said specific occasions;
logic arranged to retrieve third data from a third database relating to a curriculum of required subjects; and
logic arranged to associate said first, second and third data to determine for each student whether any of said required subjects have not yet been taught.

### FIELD

This invention relates to systems and methods for supporting teachers providing teaching to students.

### BACKGROUND

There is in recent times an increased focus on education and in raising educational standards in all sectors. Partly as a result of this there are also increasing requirements to document the provision of education to students to be able to demonstrate that required subjects have been covered and when, particularly in the event of a complaint being made that adequate teaching has not been provided.

In many countries it is the responsibility of the individual teacher to ensure that each student receives adequate tuition on the required subjects and furthermore that adequate records are kept in order to be able to prove at a later date what was a wasn't taught. This can become a significant administrative burden, which can have a counter-productive effect on quality in terms of reducing the time teachers are able to spend teaching students. These problems are exacerbated when it is necessary to take into account student absences. Moreover teachers tend to develop their own approaches to meeting these requirements which are not necessarily efficient and make it very difficult for another teacher to take over if that becomes necessary.

### SUMMARY

When viewed from a first aspect the invention provides a system for tracking the provision of education to a plurality of students comprising:
logic arranged to retrieve first data from a first database relating to a schedule of subjects taught on specific occasions;
logic arranged to retrieve second data from a second database relating to attendance of said students on said specific occasions;
logic arranged to retrieve third data from a third database relating to a curriculum of required subjects; and
logic arranged to associate said first, second and third data to determine for each student whether any of said required subjects have not yet been taught.

When viewed from a second aspect the invention provides a method for tracking the provision of education to a plurality of students comprising:
retrieving first data from a first database relating to a schedule of subjects taught on specific occasions;
retrieving second data from a second database relating to attendance of said students on said specific occasions;
retrieving third data from a third database relating to a curriculum of required subjects; and
associating said first, second and third data to determine for each student whether any of said required subjects have not yet been taught.

When viewed from a third aspect the invention provides a software product for tracking the provision of education to a plurality of students, the software product comprising instructions which when executed on a computer cause the computer to:
retrieve first data from a first database relating to a schedule of subjects taught on specific occasions;
retrieve second data from a second database relating to attendance of said students on said specific occasions;
retrieve third data from a third database relating to a curriculum of required subjects; and
associate said first, second and third data to determine for each student whether any of said required subjects have not yet been taught.

The software product may be a physical data carrier or it may comprise signals transmitted from a remote location.

When viewed from a fourth aspect the invention provides a method of providing a software product to a remote location by means of transmitting data to a computer at that remote location, the software product comprising instructions which when executed by the computer cause the computer to:
retrieve first data from a first database relating to a schedule of subjects taught on specific occasions;
retrieve second data from a second database relating to attendance of said students on said specific occasions;
retrieve third data from a third database relating to a curriculum of required subjects; and
associate said first, second and third data to determine for each student whether any of said required subjects have not yet been taught.

Thus it will be seen by those skilled in the art that in accordance with the invention, at least in its preferred embodiments, there is provided a system which can support teachers in delivery of teaching whilst giving clear information on what subjects students have been taught, taking into account where necessary absences so that the teacher can follow up and deliver additional tuition to ensure that the student does not miss out. It also allows a clear audit trail which would assist in the defence of any future complaint that might be lodged.

In at least some implementations of the system the administrative burden should be significantly reduced because the first, second and third databases—or at least the data contained therein—will be maintained for other purposes. Thus there is often a requirement to maintain a database relating to attendance of students in any event and this data will typically indicate the times at which they the students were present which can be correlated with lesson times. A database (which may simply comprise a list) relating to a curriculum of required subjects will normally be produced for most forms of education. A database relating to the subjects which are taught on specific occasions, may comprise or be derived from a lesson plan. It will be seen therefore that a system in accordance with the invention can re-use existing information to deliver benefits to teachers as set out above.

In a set of embodiments the system comprises a module which allows the compilation of a teaching schedule which may be used as the first database or from which the first database may be derived. Such a module may interface with the third database—e.g. to provide a list of curriculum subjects from which teacher can select when preparing a particular lesson. This facilitates the association of data in the databases and also makes it easier for a teacher to plan lessons which ensure that all curriculum subjects are covered. The first and third databases may use a common set of meta-tags to facilitate matching of data between them.

The first database could comprise data describing the content to be delivered in a particular session. However in a set of embodiments it could comprise the content itself. For example the first database could comprise material in the form of text, pictures, videos, animations, sound etc. which forms all or part of the material to be delivered to students for a particular lesson. Thus as well as tracking the provision of educational content, the system could also be configured to deliver it. The material conveniently comprises meta-tags or other descriptions of its content to allow matching with the third database. The material could, for example take the form of a presentation or playlist which can be streamed to a screen, interactive whiteboard etc, or to individual users' devices. It could also enable remote learning over the internet. Compilations of content such as playlists could comprise material generated or provided by the teacher, selected from a library of content provided by the system or a combination of the two. Conveniently the actual content is stored on a remote server accessible over the Internet—i.e. it is stored in ‘the cloud’.

The second database could comprise data from a learning management system or other absentee tracking system. Where students are remote from the teacher it could require periodic or random presence validation—e.g. by entering a specific code requested during the teaching session.

The first, second and third databases may be held remotely from the system and accessible over a private or public network such as the Internet. The databases may be separate, e.g. held on separate servers, although equally they may only be identifiable as logical constructs and in fact they could be hosted together and even form part of a single, larger database.

Certain preferred embodiments of the invention will now be described, by way of example only, and with reference to the accompanying drawings in which:

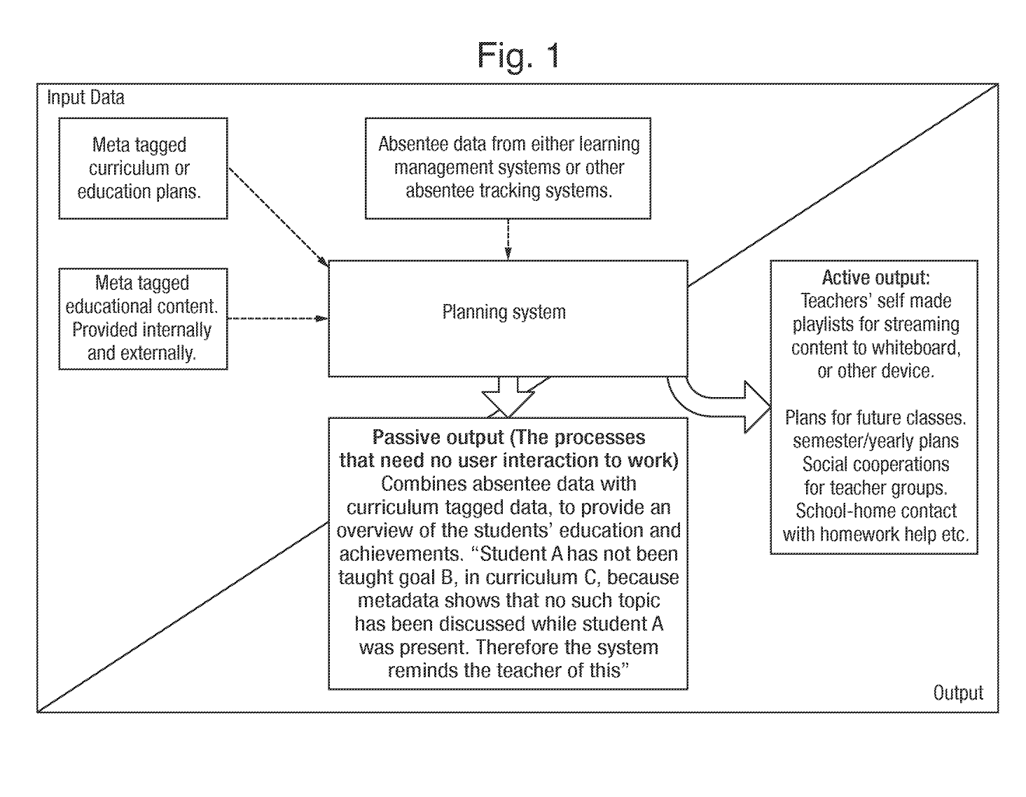

FIG. 1 shows a schematic diagram of a teaching support system; and

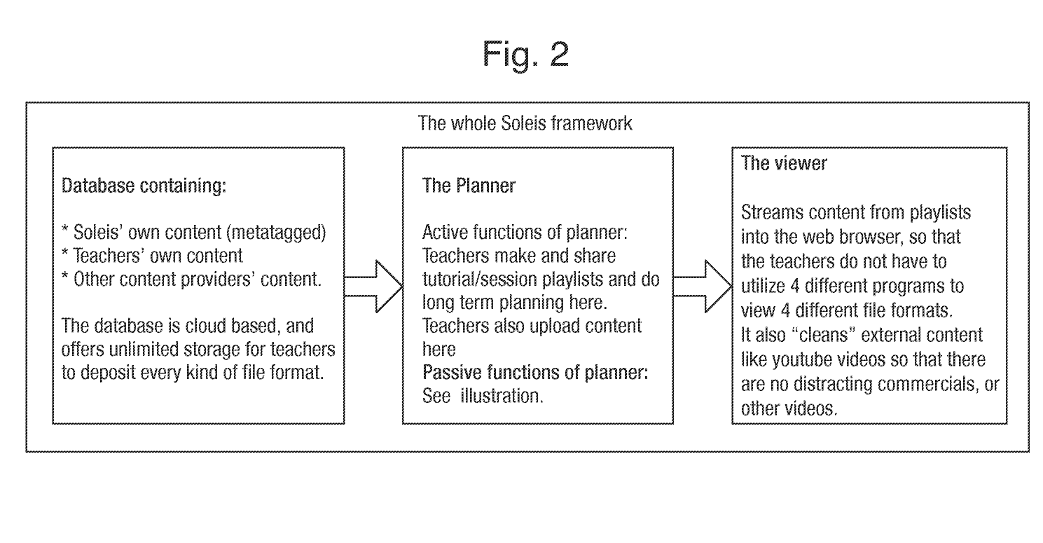

FIG. 2 is a flow diagram illustrating use of the system.

FIG. 1 schematically shows an system according to an embodiment of the invention. The system has a planning system shown as the central element of the system with system inputs shown in the upper left of the diagram and system outputs shown in the lower right of the diagram.

Three inputs to the planning system are shown in FIG. 1; meta-tagged education content data, absentee data, and meta-tagged curriculum data. These inputs are fed into the system and are associated therein.

Two outputs from the planning system are shown in FIG. 1; passive output and active output. Passive output includes reports and/or logs of the associated data, e.g. reports on which parts of the curriculum a given student has or has not been taught. The output can also include reminders or alerts if certain topics have not been covered (in general or for a particular student). Active output includes actual provision of teaching content, e.g. streaming of audio and/or visual content to a display device such as a monitor, projector or active white board. Such content can be delivered in a classroom by a teacher or can be delivered remotely to a user's terminal (e.g. a home personal computer) for remote learning.

FIG. 2 illustrates use of the system. First, content/data are provided to the system. This can include teaching content (e.g. teaching material) as well as curriculum content (e.g. a list of required teaching topics). It will be appreciated that this data may be loaded in advance or loaded during operation of the system. For example, new content can be added or lesson plans can be adjusted. Absentee data will be loaded when it is available.

In the second stage (the planning stage), a teacher is able to select preloaded content (e.g. provided with the system), create new content or upload content from a third party and match the content to the curriculum to ensure all required topics are covered. The teacher can thereby make appropriate lesson plans to cover the curriculum.

In the third stage, the teaching content is delivered to students, e.g. via a viewer. As the content is delivered, the system database can be updated to reflect what subject matter was delivered and the date and time of delivery. This can later be matched to the absentee data and also to the curriculum data via meta-tags.

As described above, the system provides advantages in facilitating tracking of what subject matter has been taught to which students. The system can readily identify where certain individual students have missed certain curriculum topics so that this can be remedied. Additionally, the system provides a rigorous history of content delivery which can be used in the event of a complaint regarding a student's education.

The centralised system also facilitates transfer of a group of students from one teacher to another (for example in the event of illness, abrupt termination of contract or death of a teacher). A new teacher can readily identify from the system what topics have been taught to which students, which allows the new teacher to be brought up to speed much faster and in a more efficient manner. Additionally, any pre-planned lessons and pre-planned content can be made available to the new teacher.

1. A system for tracking the provision of education to a plurality of students comprising:
logic arranged to retrieve first data from a first database relating to a schedule of subjects taught on specific occasions;
logic arranged to retrieve second data from a second database relating to attendance of said students on said specific occasions;
logic arranged to retrieve third data from a third database relating to a curriculum of required subjects; and
logic arranged to associate said first, second and third data to determine for each student whether any of said required subjects have not yet been taught.

2. The system of claim 1, further comprising a module arranged to allow the compilation of a teaching schedule.

3. The system of claim 2, wherein the teaching schedule is used as the first database or the first database is derived from the teaching schedule.

4. The system of claim 2, wherein the module is arranged to interface with the third database.

5. The system of claim 1, further comprising a set of meta-tags, wherein the set of meta-tags is common to the first and third databases to facilitate matching of data between them.

6. The system of claim 1, wherein the first database comprises the content to be delivered in a particular session.

7. The system of claim 6, wherein the content comprises one or more of material generated or provided by a teacher, and material selected from a library of content provided by the system.

8. The system of claim 6, wherein the content is stored on a remote server accessible over the internet.

9. The system of claim 7, wherein the material comprises meta-tags or other descriptions of its content arranged to allow matching with the third database.

10. The system of claim 7, wherein the material comprises a presentation or playlist arranged to be streamed to a screen, interactive whiteboard or to individual users' devices.

11. The system of claim 1, wherein the first database comprises material in the form of one or more of text, pictures, videos, animations and sound.

12. The system of claim 1, wherein the system is arranged to enable remote learning over the internet.

13. The system of claim 12, wherein the system is arranged to require periodic or random presence validation.

13. The system of claim 1, wherein the second database comprises data from a learning management system or other absentee tracking system.

15. The system of claim 1, wherein the first, second and third databases are held remotely from the system and are arranged to be accessible over a private or public network.

16. The system of claim 1, wherein the databases are separate.

17. A method for tracking the provision of education to a plurality of students comprising:
retrieving first data from a first database relating to a schedule of subjects taught on specific occasions;
retrieving second data from a second database relating to attendance of said students on said specific occasions;
retrieving third data from a third database relating to a curriculum of required subjects; and
associating said first, second and third data to determine for each student whether any of said required subjects have not yet been taught.

18. A software product for tracking the provision of education to a plurality of students, the software product comprising instructions which when executed on a computer cause the computer to:
retrieve first data from a first database relating to a schedule of subjects taught on specific occasions;
retrieve second data from a second database relating to attendance of said students on said specific occasions;
retrieve third data from a third database relating to a curriculum of required subjects; and
associate said first, second and third data to determine for each student whether any of said required subjects have not yet been taught.

19. The software product of claim 18, wherein the software product comprises a physical data carrier or comprises signals transmitted from a remote location.

20. A method of providing the software product of claim 18 to a remote location by means of transmitting data to a computer at that remote location.
